(19) United States
(12) Patent Application Publication
(10) Pub. No.: US 2012/0285829 A1
(43) Pub. Date: Nov. 15, 2012

(54) DETECTING ANALYTES

(75) Inventors: Andrew Mount, Edinburgh (GB); Mizanur Khondoker, Edinburgh (GB); Ilenia Ciani, Edinburgh (GB); Till Bachmann, Edinburgh (GB); Peter Ghazal, Edinburgh (GB)

(73) Assignee: ITI SCOTLAND LIMITED, Glasgow (GB)

(21) Appl. No.: 13/514,889

(22) PCT Filed: Dec. 7, 2010
(86) PCT No.: PCT/EP2010/069043

§ 371 Date: Jul. 19, 2012

(30) Foreign Application Priority Data
Dec. 9, 2009 (GB) 0921537.7
Mar. 29, 2010 (GB) 1005177.9

(51) Int. Cl. G01N 27/26; B82Y 99/00

(52) U.S. Cl. 204/450; 977/773; 977/774

(57) ABSTRACT

Provided is a method for detecting an analyte, which method comprises:
a) applying an alternating voltage to the analyte, wherein the alternating voltage comprises a plurality of superimposed frequencies sufficient to distinguish the presence of the analyte by electrochemical impedance spectrometry (EIS); and
b) determining the identity and/or quantity of the analyte from EIS data.

The present invention relates to methods for detecting an analyte using enhanced electrochemical impedance spectroscopy (EIS) techniques to obtain data on the analyte. The method is advantageous since it may result in enhanced speed over known EIS assay methods, and therefore may improve time to result (TTR) and facilitate development of such assays in the near patient environment.

Methods for detecting analytes are well known in the field of biochemical analysis. In traditional methods the analyte is labelled, usually with a fluorescent label, which can be detected, for example by fluorescence detection, in order to identify the analyte.

In the past few years in the field of DNA detection, nanoparticles have been used as the labels. These labels will potentially work for any system that permits labelling and involves binding, thus may be useful in a live cell system, as well as proteins and nucleic acids. The nanoparticles have been found to overcome a number of limitations of more traditional fluorescent labels including cost, ease of use, sensitivity and selectivity (Fritzsche W, Taton T A, Nanotechnology 14 (2003) R63-R73 “Metal nanoparticles as labels for heterogeneous, chip-based DNA detection”). Nanoparticles have been used in a number of different DNA detection methods including optical detection, electrical detection, electrochemical detection and gravimetric detection (Fritzsche W, Taton T A, Nanotechnology 14 (2003) R63-R73 “Metal nanoparticles as labels for heterogeneous, chip-based DNA detection”). The use of gold nanoparticles in the detection of DNA hybridization based on electrochemical stripping detection of the colloidal gold tag has been successful (Wang J, Xu D, Kawde A, Poslky R, Analytical Chemistry (2001), 73, 5576-5581 “Metal Nanoparticle-Based Electrochemical Stripping Potentiometric Detection of DNA hybridization”). The use of semiconductor nanocrystals, also called quantum dots, and gold nanoparticles have also been successfully used as fluorescent labels for DNA hybridization studies (West J, Halas N, Annual Review of Biomedical Engineering, 2003, 5: 285-292 “Engineered Nanomaterials for Biophotonics Applications: Improving Sensing, Imaging and Therapeutics”).

Despite the advantages discovered by using nanoparticles in DNA detection methods instead of the previous fluorescent labels, there is still a need to improve the sensitivity, selectivity and in particular the speed of the detection methods. Whilst each detection method has a certain degree of sensitivity and selectivity, they each have different limitations and produce different inaccuracies and each is not as quick as desired, especially for near patient environment testing where a short time to result (e.g. approximately 10 minutes) is desirable.

Further to such methods, nanoparticle labelling has been combined with electrophoresis in detecting DNA (see WO 2009/112537). The electrophoresis is employed to speed up binding of the DNA to complementary probes on an electrode surface. The method is advantageous since it may result in enhanced speed and sensitivity over known assay methods.

In addition to this there is also a growing need for cheap and simple detection methods, particularly for DNA in the near patient environment. To reduce cost, simplify methods, and improve speed of detection, it has been known to dispense with labelling altogether. Whilst detection methods that don't use labels might have these advantages, it is challenging to achieve the flexibility and sensitivity of detection that labels provide.

In the past electrochemical impedance spectroscopy (EIS) techniques have been considered for obtaining data on analytes both with and without using labels. The following references provide background details;

Review of applications of EIS to Biosensing—Daniels, J. S., Pourmanda, N., “Label-Free Impedance Biosensors: Opportunities and Challenges”, Electroanalysis, 19, 2007, 1239-1257.

Review of applications of EIS to Biosensing—Katz, E., Willner, I., “Probing Biomolecular Interactions at Conductive and Semiconductive Surfaces by Impedance Spectroscopy: Routes to Impedimetric Immunosensors, DNA-Sensors, and Enzyme Biosensors”, Electroanalysis 15, 2003, 913-947.

Characterisation of impedance spectrum of nanoscale electrodes of various dimensions in KCl solutions—Laureyn, W., Van Gerwen, P., Suls, J., Jacobs, P., Maes, G., Electroanalysis, 13, 2001, 204-211.

AC impedance and spectroscopy for the detection of enzyme activity—Laureyn, W., Van Gerwen, P., Suls, J., Jacobs, P., Maes, G., Electroanalysis, 13, 2001, 204-211.

AC impedance and IDEs in an integrated system—Zou, Z., Kai, J., Rust, M. J., Han, J., Ahn, C. H., “Functionalized nano interdigitated electrodes arrays on polymer with integrated microfluidics for direct bio-affinity sensing using impedimetric measurement.” Sens. Acts. A, 136, 2007, 518-526.

“In situ hybridization of PNA/DNA studied label-free by electrochemical impedance spectroscopy”, J Liu, S. Tian, P. Nielsen, W. Knoll, Chem. Commun , 2005, 2969-2971.

From this it can be seen that AC impedance measurements (also often called electrochemical impedance spectroscopy, or EIS) typically involve the application of a sinusoidal small amplitude (˜10 mV) AC voltage perturbation between two electrodes and the measurement of the resulting current between them as a function of AC frequency, from which the impedance as a function of frequency can be calculated. Changes in such impedance spectra have been shown to provide a method for sensitive label-free measurement of probe-target binding in specific surface films on electrodes, particularly when using interdigitated electrodes (IDE) such as interdigitated microelectrodes (IME) or interdigitated nanoelectrodes (INE). However, these measurements usually rely on equilibration of binding of the analyte either to the electrode, or to a probe attached to the electrode, as this determines the amount of target bound in the layer. The EIS response will thus follow equilibrium thermodynamics. This procedure requires equilibrating for extended periods, often several hours, and sometimes at elevated temperatures, to ensure complete probe-target association prior to measurement. This precludes a rapid time-to-result (TTR).

In addition to this, the impedance response of IDEs has been considered theoretically and analysis is typically carried out using appropriate electrical equivalent circuits, fitting to the response over a wide frequency range to give parameters for equivalent electrical circuit elements (resistors, capacitors, Warburg elements, etc.) from which characteristic physical parameters (e.g. diffusion coefficients, concentrations, layer thicknesses) indicative of changes in electrochemical response can be extracted. Furthermore, sequential measurement at each frequency is usually employed. Together these factors add to the relatively large time-to-results discussed above, because they contribute to extended analysis and measurement times.

Thus, known EIS methods, especially label-free methods, are typically slow, and do not provide satisfactory time to result for use in a near patient environment setting required in the present invention.

It is an aim of this invention to overcome the problems associated with the above prior art. In particular, it is an aim of this invention to provide a method for detecting an analyte with good sensitivity and selectivity which also has improved speed and time to result, and is cheap and simple to carry out.

Accordingly, the present invention provides a method for detecting an analyte, which method comprises:
a) applying an alternating voltage to the analyte, wherein the alternating voltage comprises a plurality of superimposed frequencies sufficient to distinguish the presence of the analyte by electrochemical impedance spectrometry (EIS); and
b) determining the identity and/or quantity of the analyte from EIS data.

This first aspect of the invention preferably utilises statistical analysis to determine a set of frequencies to be superposed and applied in step (a). Statistical methods for determining frequencies in this manner are well known in the art, and the skilled person may employ any known method to determine the set of frequencies to use in the present methods. Such methods can, for example, be found in “Statistical methods in Experimental physics” (2nd Editition) by World Scientific Publications Co. Pte. Ltd. Singapore. Ed. By F. James (2006) ISBN 981-256795.

Other methods of determining the set of frequencies may be employed if desired. For example, for a particular system (e.g. specific electrode/solution/analyte combination) an empirical method may be employed in advance to find a set of frequencies that will suffice as a standard for that particular system. The standard may then be employed in that system without calculating the required frequencies on every occasion the method is performed. Any other method may also be employed, either in real time or in advance, provided that it produces a viable set of frequencies to employ and does not adversely affect TTR.

No matter which method is used to determine the set of frequencies, the set should include at least the minimum number of frequencies required to be sufficient to distinguish the presence of the analyte using EIS. Additional frequencies to the minimum may of course be employed, if desired.

The method may in some embodiments, either in addition to the set of frequencies or in place of the set of frequencies, involve determination of other parameter(s) that in themselves will define a set of frequencies, and thus aid in achieving detection of the presence and/or quantity of the analyte. In each case, the frequencies and/or parameters are selected with a view to providing the fastest time to result through data analysis.

Typically the set of frequencies and/or parameters is sufficient to distinguish the presence or absence of the analyte. The specification of the set of frequencies is not particularly limited, and they may be defined as a set of specific individual frequencies, a set of frequencies within a range, and/or a single frequency with spacings from it, which define further frequencies in the set.

The analysis of the results of the EIS measurements using the superposed frequencies is preferably statistical and does not need to employ an equivalent circuit method of analysis, which typically enables faster discrimination. However, the equivalent circuit method, and any other method, is not precluded provided that TTR is not adversely affected. Fast Fourier transform (FFT) analysis may be used to extract the necessary EIS data, and this information is employed to provide analyte information. Such FFT techniques are well known in the art, and the skilled person may employ any such technique in the present invention, as desired.

As mentioned above, preferably information on the analyte presence or absence may be obtained from the EIS data, and more preferably the quantity of the analyte present may also be determined

The invention confirms that EIS biosensing and discrimination can be achieved using a small number of points over a restricted range of frequency (in Example 1 (see below) seven points over one decade of frequency), which enables the simultaneous application of a multiwaveform (in Example 1, a multisine) EIS perturbation containing the necessary frequencies, with fast Fourier transform (FFT) analysis used to extract the necessary information. Such a procedure enables measurement and analysis using commercially available instrumentation within a few seconds, enabling EIS measurement on a realistic timescale for rapid and robust detection.

Any analyte may be detected in the present invention, and the method of detection will depend on the type of analyte involved. Some analytes may bind to the electrode directly, whilst others (e.g. DNA) may bind to a probe or complementary molecule on the surface of the electrode. The set of frequencies employed in the invention will depend on the type of binding occurring for each particular system under investigation, as well as the physical nature of the system itself (electrode type, electrode composition, electrode dimensions, analyte composition, solvent/liquid medium type, electrolyte etc.). For similar systems, standard frequency sets may be employed, and for new systems or analytes a real-time statistical calculation may be employed, as explained above.

The present invention further provides a method for detecting an analyte, which method comprises:
a) applying an alternating voltage to the analyte;
b) determining the rate of change of EIS measurements across the analyte;
c) determining the identity and/or quantity of the analyte from rate of change data.

It is particularly preferred in this second aspect of the present invention, that the EIS measurements are measurements of electron transfer resistance, Rₑₜ. For typical EIS measurements made in real time, one parameter particularly sensitive to probe film formation and probe-target hybridisation is the electron transfer resistance, Rₑₜ, of a redox couple present in the system (e.g. [Fe(CN)₆]^{3-/4-}). This parameter is well known in the art, and may be calculated from the width of the semicircular feature in a Nyquist plot of the EIS spectra.

This aspect of the present invention provides an IDE measurement protocol to enable in situ kinetic measurement of the EIS response for analyte binding, either with the electrode surface or via probe-analyte hybridisation. In common with the employment of multiple superposed frequencies, it leads to much shorter EIS measurement time. Also in common with the first aspect, any analyte may be detected, and the specifics of the method of detection will depend on the type of analyte involved. Some analytes may bind to the electrode directly, whilst others may bind to a probe or complementary molecule on the surface of the electrode. The exact nature of the Rₑₜ data will depend on the type of binding envisaged for each particular system under investigation.

As has been alluded to above, in this aspect of the invention, it is preferred that both oxidation states of the redox probe (e.g. ferricyanade and ferrocyanide) are present in the solution. This ensures the DC potential at the IDEs is fixed by the reduction potential of redox probes throughout the method and means that potentials can be applied between the two IDEs without using an external reference electrode. This enables the ready application of a small amplitude EIS perturbation voltage between the two electrodes in the IDEs to measure the EIS response. Such measurements enable the EIS response to be measured with time on exposure to the solution.

As has been mentioned, the currently known EIS protocol measures the approach to equilibrium of electrode/analyte binding (or analyte/probe binding as in the case where a probe is attached to the electrode). This results in a change (typically increase) in the EIS signal to a constant value, indicative of equilibration. In this case, as the measurement is taken in the solution, the time for equilibration and equilibrium EIS signal are determined in real time, leading to optimum equilibrium measurement. However, the time to result is slow, since complete equilibration is required before a result can be determined, and this is often a lengthy process, controlled by the rates of analyte binding and release. In the second aspect of this invention, as described above, the rate of increase of the EIS signal is used and analysed to determine the concentration of analyte in solution; as electrode/analyte binding (or probe/analyte binding) is measured kinetically. This can be achieved with a much more rapid TTR, of minutes or less, and full equilibrium does not need to be reached.

In the present invention, the EIS data preferably comprises data parameters derived from the complex impedance (x+iy). These parameters are well known to the person skilled in the art and may be selected from one or more of the following:
Real component (x)
Imaginary component (y)
Modulus or absolute value [r=|z|=(x²+y²)^{1/2}]
Angle [θ=tan−1(y/x)]
Principal component 1
Principal component 2

The number of superimposed frequencies employed in the invention is not especially limited, provided that they are suitable for analysis using EIS to give the identity and/or quantity of the analyte to the required accuracy. Typically, the minimum number of superimposed frequencies is from 2-20. More preferably the minimum number of superimposed frequencies is at least 3-10, i.e. at least 3, at least 4, at least 5, at least 6, at least 7, at least 8, at least 9 or at least 10. Most preferably the number of superimposed frequencies is about 7.

The invention further provides a method for detecting an analyte, which method comprises:
a) applying an alternating voltage to the analyte;
b) determining the rate of change of EIS measurements across the analyte;
c) determining the identity and/or quantity of the analyte from rate of change data.

In the present invention, the type of EIS measurements employed are not especially limited. However, preferably the EIS measurements are measurements of electron transfer resistance, Rₑₜ. Typically the EIS measurements are measurements calculated from finding the width of the semicircular feature in a Nyquist plot, and in general Rₑₜ can be calculated using this approach.

As has been mentioned, it is preferred that the present method takes place in a liquid medium. Preferably the liquid medium is selected so as to aid in the process. An acidic medium is preferred, and preferably the liquid medium comprises H₂SO₄.

The present invention will be described in further detail with reference to the accompanying Figures, in which:

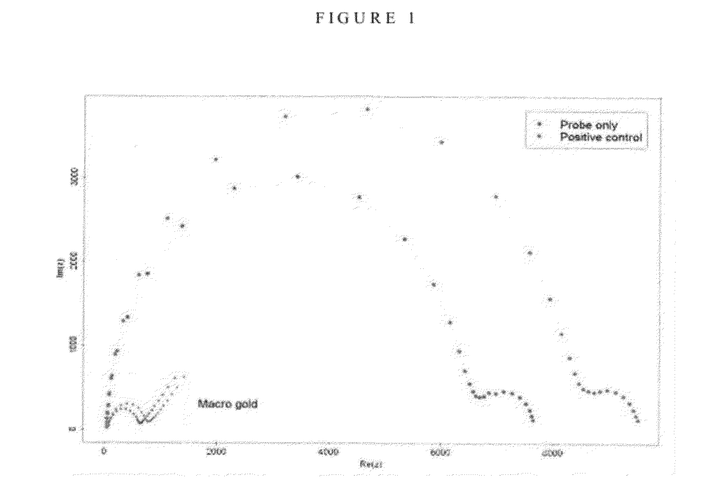

FIG. 1 shows typical Nyquist plots of EIS data from Macro gold (small Z values) and interdigitated micro (IME) electrodes.

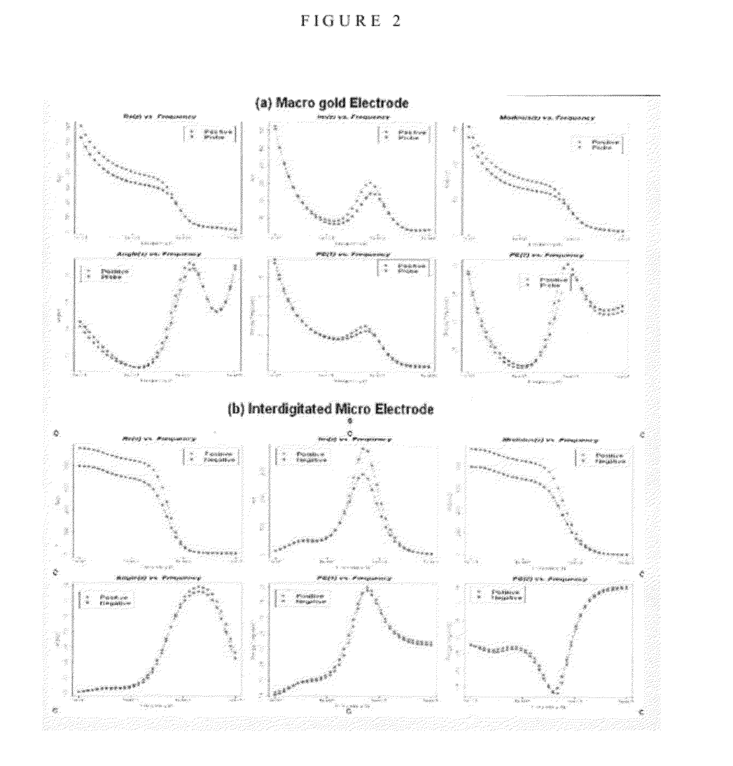

FIG. 2 shows plots of real component (x), imaginary component (y), modulus (r), angle (θ), Principal component 1, and Principal component 2 against frequencies for the data for positive controls and immobilised probes for both macro and interdigitated electrodes.

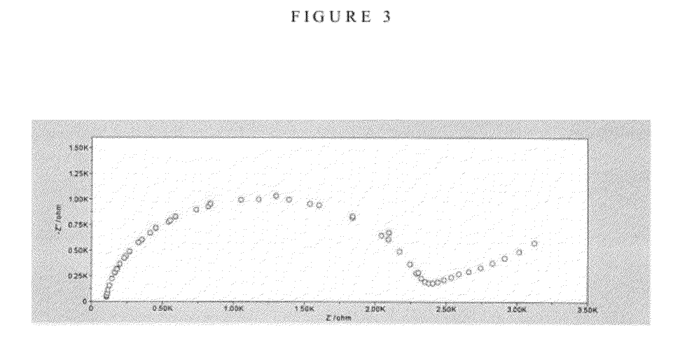

FIG. 3 shows the EIS response of gold protein macroelectrodes (6700 pM antibody) from normal single sine sequential EIS measurement with approximately 23 seconds simultaneous FFT analysis (black—recording time over two minutes; red—5 multisine EIS measurement over 9 seconds; blue—15 multisine EIS measurement every 9 seconds).

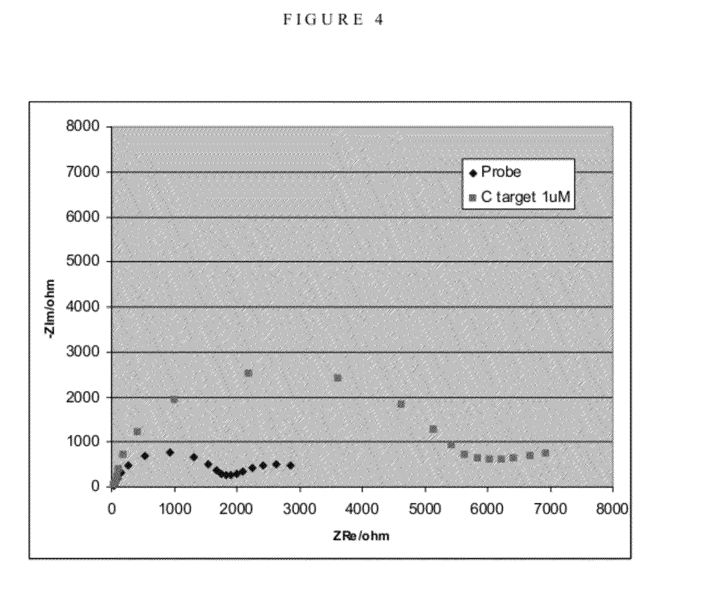

FIG. 4 shows a comparison of the Nyquist plots of modified gold electrode with 69-mer HCV DNA probe and blocked with 1 mM MCH (diamonds), and hybridization with 1 μM of complementary target (ITI 025) (squares). The impedance measurements were carried out in 2×SSC containing 10 mM [Fe(CN)₆]³⁻ and 10 mM [Fe(CN)₆]⁴⁻ (plus probe or target) at an applied dc potential between the electrodes in the IDE pair of 0 V.

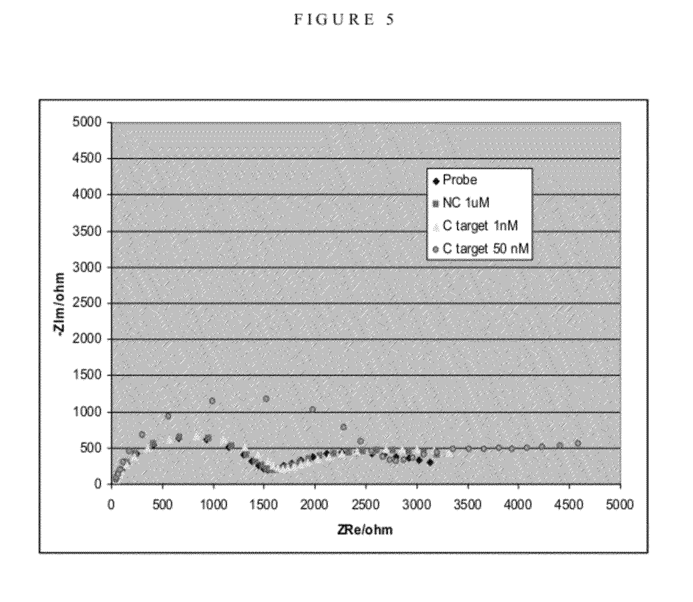

FIG. 5 shows a comparison of the Nyquist plots of modified gold electrode with 69-mer HCV DNA probe and blocked with 1 mM MCH (diamonds), hybridization with 1 μM of non complementary target (ITT 012) (squares), hybridization with 1 nM (triangles) and 50 nM (circles) complementary target (ITI 025). The impedance measurements were done in 2×SSC containing 10 mM [Fe(CN)₆]³⁻ and 10 mM [Fe(CN)₆]⁴⁻ (plus probe or target) at an applied dc potential between the electrodes in the IDE pair of 0 V.

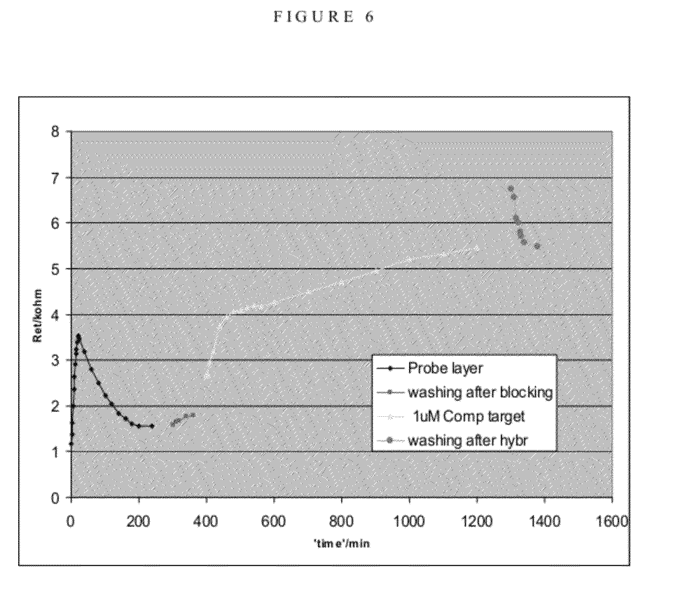

FIG. 6 shows Rₑₜ versus time EIS measurements during probe (thiol-DNA) layer formation (diamonds), after blocking with MCH (squares), during hybridization with 1 μM complementary target (triangles) and washing after hybridization (circles).

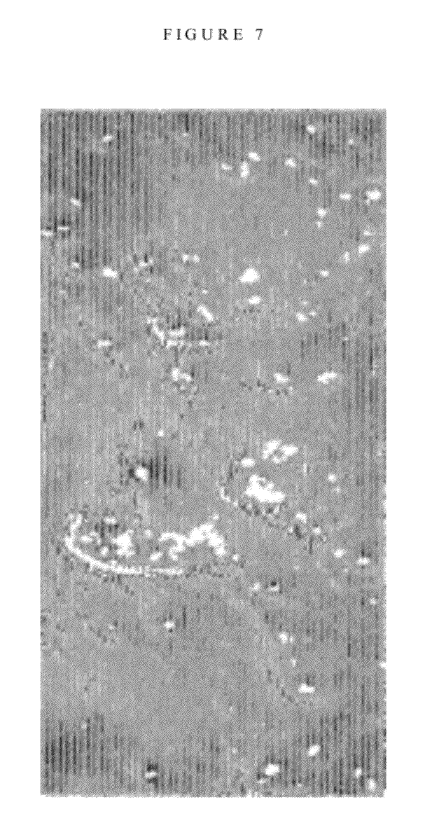

FIG. 7 shows fluorescence measurement after EIS measurement of complementary target (50 nM) binding and 20 nM QD incubation; PMT setting 180.

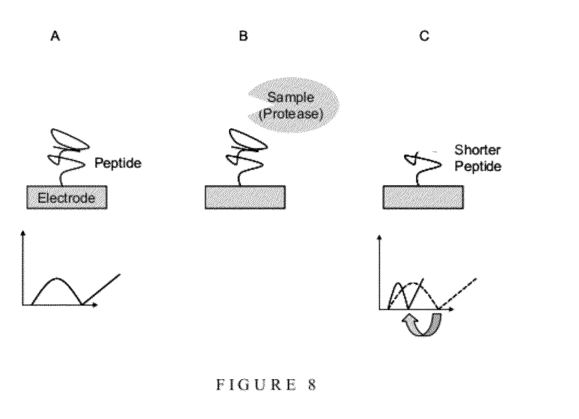

FIG. 8 shows a schematic of EIS measurement of impedimetric protease activity. To measure the activity of a protease (e.g. MMP8 or 9) their respective substrate (peptide) is immobilised on an electrode or device suitable to measure AC impedance (A). The system displays an initial impedance behaviour described in the schematic graph in (A). The incubation of the system with a sample containing the desired protease (B) will lead to a shortening of the immobilised peptide leading to a changed impedance signal, e.g. a reduced Rₑₜ value as indicated in the schematic graph in (C).

The methods of both aspects of the invention have a number of specific advantages over known methods: fast time to result (TTR) in seconds to minutes compatible with near patient environment requirements; wide applicability of approach to different probe-target systems; compatibility with rapid multisine EIS for enhanced data collection; EIS detection compatibility with electronic control and measurement; and label-free detection.

The analyte for detection in both aspects of the present method is not especially limited, but is preferably a biomolecule. Preferably, the analyte is selected from a cell, a protein, a polypeptide, a peptide, a peptide fragment, an amino acid, DNA and RNA. The method of the present invention is particularly useful for DNA and RNA detection.

The method of the present invention may be used to detect either a single analyte or a plurality of different analytes simultaneously.

Preferably, the method of the present invention is a label-free method, i.e. there is no requirement to label the analyte in order to aid in detection. However, in some circumstances labels may be employed. For example, when the method is used to detect a plurality of different analytes simultaneously, each different analyte may be labelled with one or more different labels relatable to the analyte. Alternatively, multiple analytes may be detected by spatial separation, such as by arraying a set of probes for the analytes on a surface. Detection of a plurality of different analytes is also known as multiplexing.

In the electrochemical detection methods of the invention, the analyte is investigated in solution or suspension in a liquid medium. The liquid medium is not particularly limited provided that it is suitable for analysis using EIS. Preferably the liquid medium comprises an electrolyte to facilitate the EIS measurement. The electrolyte is a solvent or buffer containing inert ions e.g. PBS; typically redox active species are then added at much lower concentrations. The electrolyte is not particularly limited, and may include any electrolyte known in the art. However electrolytes containing transition metal redox systems are preferred, such as Fe(II)/Fe(III) electrolyte systems. [Fe(CN)₆]^{3-/4-} is particularly preferred.

If a plurality of different labels is used to label different analytes, preferably each label has a different oxidation potential for the electrochemical detection method and, therefore, produces different signal peaks in the data obtained. For example, when metal nanoparticles are used as labels for different analytes (see below) different metals with different oxidation potentials may be used for each analyte.

In preferred embodiments the alternating potential applied to the electrode is not especially limited, and depends upon the medium employed. Thus, in practice, the largest possible amplitude for EIS is fixed by the solvent limits (for water around 2V, giving a rms amplitude of around 1-2V). Accordingly, in aqueous media the potential may be from +1.0 to +2.0 V, and preferably from +1.2 V to +1.8 V. When using redox species in the system, both oxidised and reduced species are present and this typically results in the use of less than 250 mV amplitude. In more preferred embodiments, the alternating voltage applied between electrodes is of amplitude about 10 mV root mean squared (rms). This enables the response to be linearised for e.g. equivalent circuit analysis. Higher amplitude responses can be used (and if statistical methods are to be employed to extract characteristic signals, they could be different/advantageous).

In a preferred embodiment, the electrical detection method is carried out on a chip. In the multiplexing embodiment of the present invention, where label(s) are used for optical detection, the optical and electrical detection may be carried on one chip when the analyte(s) have been labelled with the different labels simultaneously. Alternatively, where the analyte(s) have been separated into two aliquots and labelled separately they may then be combined after labelling for optical and electrical detection on one chip or optical and electrical detection may be carried out separately on two separate chips.

In one embodiment of the present invention the analyte(s) is nucleic acid and the labelling step is performed using labelled primers and primer extension using labelled nucleosides. The labelled extended primer may be hybridised to a probe for optical and electrical detection. This is particularly advantageous because it allows the label(s) for electrical detection to be positioned in close proximity to the electrode for detection.

Using EIS, the amount of analyte present can be quantified by voltammetry. Quantitative data can be obtained from the signal peaks by integration, i.e. determining the area under the graph for each signal peak produced.

### Embodiments Employing Labelling

In some preferred embodiments of the present invention, labels are employed, in particular when multiplexing is desirable. The labels referred to are not especially limited, but are preferably selected from nanoparticles, single molecules, intrinsic components of the target such as specific nucleotides or amino acids, and chemiluminescent enzymes. Suitable chemiluminescent enzymes include HRP and alkaline phosphatise. Fluorescent labels are particularly preferred, since optical detection of the labels is readily combined with the electrochemical methods of the invention.

Preferably, the labels are nanoparticles. Nanoparticles are particularly advantageous in these embodiments of the present invention because they operate successfully in electrical detection methods. The proximity of the nanoparticles to the surface is not especially important, which makes the assay more flexible. In a preferred embodiment the nanoparticles comprise a collection of molecules because this gives rise to greater signal in optical and electrical detection methods than when single molecules are used.

Preferably the nanoparticles are selected from metals, metal nanoshells, metal binary compounds and quantum dots. Examples of preferred metals or other elements are gold, silver, copper, cadmium, selenium, palladium and platinum. Examples of preferred metal binary and other compounds include CdSe, ZnS, CdTe, CdS, PbS, PbSe, HgI, ZnTe, GaAs, HgS, CdAs, CdP, ZnP, AgS, InP, GaP, GaInP, and InGaN.

Metal nanoshells are sphere nanoparticles comprising a core nanoparticle surrounded by a thin metal shell. Examples of metal nanoshells are a core of gold sulphide or silica surrounded by a thin gold shell.

Quantum dots are semiconductor nanocrystals, which are highly light-absorbing, luminescent nanoparticles (West J, Halas N, Annual Review of Biomedical Engineering, 2003, 5: 285-292 “Engineered Nanomaterials for Biophotonics Applications: Improving Sensing, Imaging and Therapeutics”). Examples of quantum dots are CdSe, ZnS, CdTe, CdS, PbS, PbSe, HgI, ZnTe, GaAs, HgS, CdAs, CdP, ZnP, AgS, InP, GaP, GaInP, and InGaN nanocrystals.

Any of the above labels may be attached to an antibody.

The size of the labels is preferably less than 200 nm in diameter, more preferably less than 100 nm in diameter, still more preferably 2-50 nm in diameter, still more preferably 5-50 nm in diameter, still more preferably 10-30 nm in diameter, most preferably 15-25 nm.

When the method of the present invention is for detecting a plurality of analytes, each different analyte is labelled with one or more different labels relatable to the analyte. In this aspect of the invention, the labels may be different due to their composition and/or type. For example, when the labels are nanoparticles the labels may be different metal nanoparticles. When the nanoparticles are metal nanoshells, the dimensions of the core and shell layers may be varied to produce different labels. Alternatively or in addition, the labels have different physical properties, for example size, shape and surface roughness. In one embodiment, the labels may have the same composition and/or type and different physical properties.

The different labels for the different analytes are preferably distinguishable from one another in the optical detection method and the electrical detection method. For example, the labels may have different frequencies of emission, different scattering signals and different oxidation potentials.

In embodiments of the present invention where labelling is employed, such as in multiplexing, the method typically comprises a further initial step of labelling the analyte with one or more labels to form the labelled analyte.

The means for labelling the analyte are not particularly limited and many suitable methods are well known in the art. For example, when the analyte is DNA or RNA it may be labelled by enzymatic extension of label-bound primers, post-hybridization labelling at ligand or reactive sites or “sandwich” hybridization of unlabelled target and label-oligonucleotide conjugate probe (Fritzsche W, Taton T A, Nanotechnology 14 (2003) R63-R73 “Metal nanoparticles as labels for heterogeneous, chip-based DNA detection”).

Many different methods are known in the art for conjugating oligonucleotides to nanoparticles, for example thiol-modified and disulfide-modified oligonucleotides spontaneously bind to gold nanoparticles surfaces, di- and tri-sulphide modified conjugates, oligothiol-nanoparticle conjugates and oligonucleotide conjugates from Nanoprobes' phosphine-modified nanoparticles (see FIG. 2 of Fritzsche W, Taton T A, Nanotechnology 14 (2003) R63-R73 “Metal nanoparticles as labels for heterogeneous, chip-based DNA detection”).

In one embodiment, both DNA or RNA strands may be biotinylated. The biotinylated target strand may be hybridized to oligonucleotide probe-coated magnetic beads. Streptavidin-coated gold nanoparticles may then bind to the captured target strand (Wang J, Xu D, Kawde A, Poslky R, Analytical Chemistry (2001), 73, 5576-5581 “Metal Nanoparticle-Based Electrochemical Stripping Potentiometric Detection of DNA hybridization”). The magnetic beads allow magnetic removal of non-hybridized DNA.

The EIS methods of the present invention may be employed in many different specific methods. However, they are particularly suited to protease detection, such as impedimetric protease activity detection. FIG. 8 shows a schematic which demonstrates how this may operate. To measure the activity of a protease its substrate (a particular peptide) is immobilised on an electrode or device suitable to measure AC impedance (A), such as the devices used in the methods of the present invention. The system displays an initial impedance behaviour described in the schematic graph in (A). The incubation of the system with a sample containing the desired protease (B) will lead to a shortening of the immobilised peptide leading to a changed impedance signal, e.g. a reduced Rₑₜ value as indicated in the schematic graph in (C). In this type of arrangement it may be possible to operate the system in Faradayic and non-Faradayic mode (with and without mediator, e.g. ferro/ferricyanide).

The advantage of this aspect of the invention is that no additional reagents need to be introduced in the test to measure the protease activity. The system has the potential to be multiplexed as many proteases could be measured in the same sample and reaction space. The system also is potentially much faster than conventional systems as kinetic impedance measurements can be done in a multiplexed manner.

Any protease may be detected, and the type of protease is not especially limited. However, in some embodiments, proteases associated with wounds are employed. Typically these proteases are ones which are present in wounds that are not healing. Two proteases that are of particular interest are MM8 and MM9.

The present invention will be described further by way of example only.

### EXAMPLES

### Example 1

### Investigating EIS Parameters for Multiple Frequency Analysis

In order to investigate the optimum parameters to use in the method of the first aspect of the invention, any EIS set-up may be employed. However, typically the electrodes, electrolytes, liquid medium, analytes (and probes if they are to be used) that will be involved in the final analysis will be employed to ensure that the parameters are as close to optimal as possible.

In this Example, probe-target hybridisation on commercial gold IDEs from Abtech was studied. An electrochemical cleaning cycle was utilised, applying to both electrodes in the IDE pair a linear potential sweep between −0.6 V and +1.65 V versus Ag/AgCl in 50 mM aqueous H₂SO₄ solution at a sweep rate of 50 mVs for 30-40 complete cycles, until a stable cyclic voltammogram (CV) characteristic of clean gold electrodes was seen. Before preparing the DNA (69-mer ITI 021) solution, the DNA probes were purified by passing them through a MicroSpin™ G-25 column (Amersham Biosciences, Buckinghamshire, UK) after cleavage of the disulfide protected nucleotides with 5 mM of TCEP solution.

Nyquist plots of a large frequency range for EIS for both macro gold and interdigitated micro (IME) electrodes were plotted, and these are shown in FIG. 1; each shows distinct signals for complementary target binding.

The differences between the positive control (probe with complementary target bound) and negative control (probe only or probe with non-complementary target) were compared in terms of parameters derived from the complex impedance, which can be written as x+iy, where i is (−1)^{1/2}. These are:
Real component (x)
Imaginary component (y)
Modulus or absolute value [r=|z|=(x²+y²)^{1/2}]
Angle [θ=tan⁻¹(y/x)]
Principal component 1
Principal component 2

These differences were investigated in terms of each of these quantities by plotting them against the logarithm of frequency (see FIG. 2).

FIG. 2 shows that for both large (macro) and small (interdigitated micro) electrodes, the real component and modulus provide similar information and best discriminate the EIS signal from the positive controls and immobilised probes, particularly at the lower end of the frequency range. The imaginary component best discriminates the EIS signal in the middle of the frequency range.

For optimising the TTR, the present invention selects the most useful range of frequency and smallest number of measurements that best discriminates between the different EIS data for all experimental conditions, and does not require employing fitting models such as equivalent circuits. Statistical analysis in this Example determined a 7-point optimal frequency range for both macro gold and interdigitated micro electrodes (IME) using the fold change between the EIS signal of the positive control and the immobilised probes.

The results are summarised in Table 1.

TABLE 1
Summary results for 7-point optimal frequency range (in Hz) for Macro
Electrode and Interdigitated Micro Electrode based on complementary
hybridisation vs. immobilised probe without target comparison.

| | No. of | Optimum Range for | Optimum Range for |
|---|---|---|---|
| Signal Type | Points | Macro Electrode | IME Electrodes |
| Modulus | 7 | [4, 44] | [3, 30] |
| Real component | 7 | [3, 44] | [3, 30] |
| Imaginary | 7 | [30, 338] | [13, 150] |
| Component | | | |

It is notable that, for both types of electrodes, the modulus data and real component give a very similar range of optimal frequencies for EIS measurement, spanning around a decade of frequency. For both types of electrode, the imaginary component gives optimal signals at slightly higher frequencies than that for real and modulus data, again spanning a decade of frequencies. The very large changes in the electrode dimensions from macro to IME have had little effect on the optimum frequency range for measurement, consistent with the response being largely independent of electrode area, which simplifies EIS measurement. Differential analysis of complementary versus mock hybridisation using fold-change gave a similar optimal frequency range to that of complementary hybridisation vs. immobilised probe signals (Table 2), confirming that the same measurement range can be used.

TABLE 2
7-point optimal frequency range in Hz for Macro Gold Electrode based
on complementary versus mock hybridisation comparison.

| Signal Type | No. of points | Optimal range |
|---|---|---|
| Modulus | 7 | [4, 44] |
| Real component | 7 | [3, 30] |
| Imaginary Component | 7 | [20, 255] |

To enable these data to be obtained rapidly, multisine techniques have been employed to apply the required multiple frequencies simultaneously, with FFT to analyse the results and extract these data. FIG. 3 shows a comparison of the EIS Nyquist plot for the previously used method of sequential application of single sines to the measured responses for 5 multisine (over one decade of frequency) and 15 multisine (over two decades of frequency) EIS measurements for a protein macroelectrode experimental system. Experimental data collection, analysis and display was achieved on a PC in several minutes for sequential application, around 7 seconds for 5 sines and around 23 seconds for 15 sines. The component frequencies for this multisine experiment have been selected to span the frequency range determined by statistical analysis, which spans the semicircular charge transfer feature in the EIS Nyquist plot shown. The extremely close correspondence of all data (typically to within 0.05%) indicates that the multisine EIS approach leads to more rapid EIS parameter extraction compatible with EIS measurement and analysis (and hence a TTR) of seconds, without compromising the accuracy of measurement.

### Example 2

### Investigating Real Time Kinetics Measurement Using EIS

In this Example, the kinetics of probe-target hybridisation on commercial gold IDEs from Abtech were studied. An electrochemical cleaning cycle was utilised, applying to both electrodes in the IDE pair a linear potential sweep between −0.6 V and +1.65 V versus Ag/AgCl in 50 mM aqueous H₂SO₄ solution at a sweep rate of 50 mVs for 30-40 complete cycles, until a stable cyclic voltammogram (CV) characteristic of clean gold electrodes was seen. Before preparing the DNA (69-mer ITI 021) solution, the DNA probes were purified by passing them through a MicroSpin™ G-25 column (Amersham Biosciences, Buckinghamshire, UK) after cleavage of the disulfide protected nucleotides with 5 mM of TCEP solution.

Immediately after cleaning, thiol-DNA probe layers were immersed in a 10 μM DNA solution in 2×SSC buffer and 10 mM of each of [Fe(CN)₆]³⁻ and [Fe(CN)₆]⁴⁻ (10 mM [Fe(CN)₆]^{3-/4-}) at room temperature. The EIS measurement was started as soon as the electrode was immersed in the DNA solution and was left to run for 3-4 h. As previously, a 10 mV RMS amplitude sinusoidal voltage was applied between the electrodes in the IDE pair at a DC voltage of 0 V throughout in these experiments, as the presence of equal concentrations of [Fe(CN)₆]³⁻ and [Fe(CN)₆]⁴⁻ ensured that the DC potential of each electrode was pinned at the reduction potential of [Fe(CN)₆]^{3-/4-}. Then, the modified surface was washed with 2×SSC for a few minutes and blocked with MCH 1 mM in water at room temperature for 30 minutes. After washing for 10-20 minutes in 2×SSC buffer, the electrode EIS signal was measured again in 10 mM [Fe(CN)₆]^{3-/4-} 2×SSC buffer to check for changes after the blocking step. The electrodes were then immersed in the target (complementary or not) DNA dissolved in 2×SSC and containing 10 mM [Fe(CN)₆]^{3-/4-} to allow EIS measurements, again at 0 V DC.

FIG. 4 shows typical impedance plots of these 69-mer thiol-DNA modified probe electrodes, before and after hybridisation with 1 μM of complementary target (ITI 025). The high frequency semicircle is the common feature for both macro and IDE electrodes, and gives information on the charge transfer through the probe film layer at the electrode surface. After addition of 1 μM of complementary target the diameter of this high frequency semicircle increases, as expected, due to complementary target-probe binding in the probe layer, whilst the lower frequency diffusion feature remains essentially unchanged, indicating (as expected) little effect on diffusion between the electrodes.

FIG. 5 shows another example of IDEs prepared in the same way. In this case, after the blocking, a negative control was carried out: for a few hours the EIS was monitored in a solution containing 1 μM non complementary (ITI 012) target and 10 mM [Fe(CN)₆]^{3-/4-} in 2×SSC. As expected, no changes were observed in the impedance signal, indicating no non-complementary target-probe binding. After this the electrode was rinsed in 2×SSC buffer and the response measured in a solution of 1 nM complementary target DNA and 10 mM [Fe(CN)₆]^{3-/4-} in 2×SSC. After 1 h, when the response was stable, the electrode was immersed in 50 nM target solution and measured overnight. The difference between probe and 1 nM target is small but significant, whilst it is easily seen for 50 nM. Thus EIS is probing complementary target binding using the established method of waiting for equilibration.

FIG. 6 now shows typical EIS measurements made in real time: the parameter sensitive to probe film formation and probe-target hybridisation is the electron transfer resistance, Rₑₜ, for [Fe(CN)₆]^{3-/4-}, which has been calculated from finding the width of the semicircular feature in the Nyquist plot of each of the EIS spectra. This has been plotted (as Rₑₜ for electron transfer) as function of time in this Figure.

These data are rich in information, and show the establishment of a probe film (diamonds), blocking and washing (squares) and the kinetics of probe-target hybridisation (triangles). When the gold electrode is exposed to probe film solution (diamonds) the value of Rₑₜ rises over the first hour or so due to probe film formation, then falls to a steady-state value after 3-4 hours, indicating a stable surface film. This is confirmed by removing the probe solution and washing, as there is little change in the observed value. Adding mercaptohexanol (MCH) to block any remaining gold surface also causes little change in resistance, as does measuring the resistance over time in buffer with [Fe(CN)₆]^{3-/4-} (squares), which again indicates a stable probe film. Having established a stable probe film, the kinetic technique is then used to monitor probe-target binding in the solution containing complementary target and ferri/ferrocyanide. On exposing the probe film to this solution (triangles), an immediate increase in Rₑₜ is seen due to complementary target-probe binding. The initial response is immediate, with the first point showing an increase in Rₑₜ and with the value more than doubling within the first hour. This method enables the measurement of EIS response kinetically every few seconds (see multisine IDF). The rate of increase in probe-target binding would typically be expected to be first order in (and certainly dependent on) target concentration; therefore analysis of the rate of rise of EIS is then possible on the seconds to minutes timescale to give target concentration. It is satisfactory that the impedance increases more slowly over several hours after this, showing the long time approach to an equilibrium response which limits the TTR of equilibrium measurement. On removing the target solution, washing and then measuring the response in buffer with [Fe(CN)₆]^{3-/4-} (circles), after a transient change in Rₑₜ the value returns initially to that observed previously, showing that the response is indicative of probe-target binding.

In order to confirm that probe layer formation and hybridisation had occurred on the gold electrode, avidin-labelled target was used and then incubated (for 1 h at room temperature) with streptavidin-labelled Qdots (20 nM in QD buffer).

It is clear from the resulting fluorescence image (FIG. 7) that as expected the regions of highest fluorescence intensity are on the gold fingers of the IDE. This confirms the enhancement of Rₑₜ observed after hybridisation is due to probe-target hybridisation in a film on the gold IDE surfaces.

1. A method for detecting an analyte, which method comprises:
a) applying an alternating voltage to the analyte, wherein the alternating voltage comprises a plurality of superimposed frequencies sufficient to distinguish the presence of the analyte by electrochemical impedance spectrometry (EIS); and
b) determining the identity and/or quantity of the analyte from EIS data;
wherein the plurality of frequencies is determined prior to step (a) by empirical methods, and includes at least a minimum number of frequencies to detect the analyte, so as to increase assay speed.

2. A method according to claim 1, wherein the EIS data comprises data parameters derived from the complex impedance (x+iy), which parameters are selected from one or more of the following:
Real component (x)
Imaginary component (y)
Modulus or absolute value [r=|z|=(x²+y²)^{1/2}]
Angle [θ=tan−1(y/x)]
Principal component 1
Principal component 2

3. (canceled)

4. A method according to claim 1, wherein the minimum number of superimposed frequencies is from 2-20.

5. A method according to claim 4, wherein the number of superimposed frequencies is at least 3-10.

6. A method according to claim 5, wherein the number of superimposed frequencies is at least 7.

7. A method according to any prcccding claim 1, wherein step (b) comprises a step of performing a Fourier transform on the EIS data.

8. A method for detecting an analyte, which method comprises:
a) applying an alternating voltage to the analyte;
b) determining the rate of change of electrochemical impedance spectrometry (EIS) measurements across the analyte;
c) determining the identity and/or quantity of the analyte from rate of change data;
wherein step (b) is carried out in real time so as to increase assay speed.

9. A method according to claim 8, wherein the EIS measurements are measurements of electron transfer resistance, Rₑₜ.

10. A method according to claim 8, wherein the EIS measurements are measurements calculated from finding the width of the semicircular feature in a Nyquist plot.

11. A method according to claim 8, wherein an electrolyte is added to the system to aid in EIS measurement.

12. A method according to claim 11, wherein the electrolyte is a transition metal complex.

13. A method according to claim 11, wherein the transition metal complex comprises the [Fe(CN)₆]^{3-/4-}system.

14. A method according to claim 1 or 8, wherein a liquid medium is employed to aid in EIS measurement.

15. A method according to claim 14, wherein the liquid medium comprises H₂SO₄.

16. A method according to claim 1 or 8, wherein the method is for analysing two or more analytes, and further comprises the step of labelling each analyte with one or more labels to form labelled analytes distinguishable from each other by their labels.

17. A method according to claim 16, wherein the one or more labels are suitable for optical and/or electrical detection.

18. A method according to claim 17, wherein the labels are selected from nanoparticles, single molecules, chemiluminescent enzymes and fluorophores.

19. A method according to claim 18, wherein the labels are nanoparticles comprising a collection of molecules and/or atoms.

20. A method according to claim 19, wherein the nanoparticles are selected from metals, metal nanoshells, metal binary compounds and quantum dots.

21. A method according to claim 20, wherein the nanoparticles are metal compounds selected from CdSe, ZnS, CdTe, CdS, PbS, PbSe, Hgl, ZnTe, GaAs, HgS, CdAs, CdP, ZnP, AgS, InP, GaP, GaInP, and InGaN.

22. A method according to claim 21, wherein the nanoparticles are selected from gold, silver, copper, cadmium, selenium, palladium and platinum.

23. A method according to claim 18, wherein the nanoparticles are less than 100 nm in diameter.

24. A method according to claim 1 or 8, wherein the optical detection method is selected from optical emission detection, optical absorbance detection, optical scattering detection, spectral shift detection, surface plasmon resonance imaging, and surface-enhanced Raman scattering from adsorbed dyes.

25. A method according to claim 24, wherein the optical detection is optical emission detection and comprises the steps of irradiating the labelled analytes with light capable of exciting the labels and detecting the frequency and intensity of light emissions from the labels.

26. A method according to claim 25, wherein the light is laser light.

27. A method according to claim 25, wherein the light is selected from infra-red light, visible light and UV light.

28. A method according to claim 27, wherein the light is white light.

29. A method according to claim 1 or 8, wherein the analyte comprises one or more compounds selected from a cell, a protein, a polypeptide, a peptide, a peptide fragment, an amino acid, DNA and RNA.

30. A method according to claim 29, wherein the analyte is a protease, preferably a protease associated with impaired wound healing, more preferably MM8 or MM9.

31. A method according to claim 30, wherein the analyte is detected using impedimetric protease activity detection.

32. A method of detecting impaired wound healing, which method comprises performing a protease detection method as defined in claim 30 or claim 31.
